(19) United States
(12) Patent Application Publication
(10) Pub. No.: US 2007/0193268 A1
(43) Pub. Date: Aug. 23, 2007

(54) Turbocharger with liquid-cooled center housing

(75) Inventors: Philippe Noelle, Vincey (FR); Nicolas Vazellie, Nancy (FR); Laurent Vautler, Tendon (FR)

Correspondence Address: HONEYWELL TURBO TECHNOLOGIES, 23326 HAWTHORNE BOULEVARD, SUITE #200, TORRANCE, CA, 90505, US

(73) Assignee: Honeywell International, Inc.

(21) Appl. No.: 11/356,532

(22) Filed: Feb. 17, 2006

(51) Int. Cl. F02B 33/44

(52) U.S. Cl. 60/605.1

(57) ABSTRACT

A turbocharger comprises a center housing interposed between a compressor housing and a turbine housing. A shaft is disposed within the center housing and has a turbine wheel attached at one end and a compressor impeller attached at an opposite end. The center housing includes an internal liquid cooling passage disposed therein that includes a compressor section and a turbine section. The compressor section is positioned adjacent a center housing wall section connected to the compressor housing, and the turbine section is positioned adjacent a center housing wall section connected to the turbine housing. The turbine and/or compressor housings include one or more variable geometry members disposed therein. The liquid-cooled center housing maintains the compressor housing wall structure below about 180° C. during turbocharger operation to minimize or eliminate the unwanted occurrence of oil deposits thereon that can impair variable geometry member movement and reduce compressor efficiency.

### FIELD OF THE INVENTION

This invention relates generally to the field of turbochargers and, more particularly, to a variable geometry turbocharger having a center housing that is specially engineered to provide liquid cooling to a compressor side of the turbocharger to control the temperature along a wall structure in the compressor housing adjacent to a variable geometry member disposed therein during turbocharger operation, thereby reduce the formation of oil deposits along the wall structure that could interfere with the desired movement of the variable geometry member and adversely impact compressor efficiency.

### BACKGROUND OF THE INVENTION

Turbochargers for gasoline and diesel internal combustion engines are devices known in the art that are used for pressurizing or boosting the intake air stream, routed to a combustion chamber of the engine, by using the heat and volumetric flow of exhaust gas exiting the engine. Specifically, the exhaust gas exiting the engine is routed into a turbine housing of a turbocharger in a manner that causes an exhaust gas-driven turbine to spin within the housing. The exhaust gas-driven turbine is mounted onto one end of a shaft that is common to a radial air compressor mounted onto an opposite end of the shaft and housed in a compressor housing. Thus, rotary action of the turbine also causes the air compressor to spin within a compressor housing of the turbocharger that is separate from the turbine housing. The spinning action of the air compressor causes intake air to enter the compressor housing and be pressurized or boosted a desired amount before it is mixed with fuel and combusted within the engine combustion chamber.

In a turbocharger it is often desirable to control the flow of exhaust gas to the turbine to improve the efficiency or operational range of the turbocharger. Variable geometry turbochargers have been configured to address this need. A type of variable geometry turbocharger is one having a variable exhaust nozzle, referred to as a variable nozzle turbocharger. Different configurations of variable nozzles have been employed in variable nozzle turbochargers to control the exhaust gas flow. One approach taken to achieve exhaust gas flow control in such variable nozzle turbochargers involves the use of multiple pivoting vanes that are positioned annularly around the turbine inlet. The pivoting vanes are commonly controlled by a unison ring, that is movably disposed within the turbocharger, to alter the throat area of the passages between the vanes, thereby functioning to control the exhaust gas flow into the turbine.

In such turbochargers, a center housing is interposed between the turbocharger turbine housing and compressor housing, and is configured internally to carry and provide lubrication to the common shaft. While oil is circulated through the center housing to provide lubrication to the shaft, air surrounding the external surface of the center housing is used for cooling the center housing and portions of the center housing adjacent the turbine and compressor housings. In some turbochargers the center housing is constructed having an internal passage, in addition to the oil lubrication passage, that is configured to receive a cooling liquid therein to reduce the extent of heat transfer from the turbine housing. Such liquid-cooled center housings, are configured having an internal liquid cooling passage intentionally positioned adjacent the turbine housing for this purpose.

Some turbochargers are known to have variable geometry members disposed both in the turbine housing, as described above, and in the compressor housing. The variable geometry members that are disposed in the compressor housing are controlled in a manner similar to that described above to achieve a desired result with respect to the air circulating through the compressor housing. In an example embodiment, the variable geometry members disposed in the compressor housing comprise a plurality of pivoting vanes positioned adjacent a wall portion of the compressor housing.

A problem known to exist with such turbochargers, comprising variable geometry members disposed within the compressor housing, is that at temperatures above about 180° C. any oil that has entered the compressor housing, e.g., coming from blow by recirculation, deposits itself on the compressor wall that is adjacent the variable geometry members. At these temperatures, the deposited oil can operate to jam or otherwise impair movement of the variable geometry members. For example, it is not uncommon for the oil deposits to cause the variable geometry members to become jammed or stuck, thereby impairing their ability to operate properly to have a desired impact on the air circulating through the compressor housing reducing compressor efficiency.

It is, therefore, desired that a turbocharger assembly be constructed in a manner that reduces or eliminates the potential for any such variable geometry members disposed within the compressor housing becoming jammed or stuck during turbocharger operation by the formation or presence of oil deposits therein.

### SUMMARY OF THE INVENTION

A turbocharger assembly constructed according to the present invention includes a center housing having a shaft disposed therethrough, a compressor housing attached to one side of the center housing and having an impeller rotatably disposed therein and attached to one end of the shaft, and a turbine housing attached to another side of the center housing and having a turbine wheel rotatably disposed therein and attached to an opposite end of the shaft. The center housing is specially engineered having an internal liquid cooling passage disposed therein.

The center housing liquid cooling passage includes a compressor section that is positioned adjacent a wall section of the center housing that is connected with and that forms a portion of the compressor housing. The liquid cooling passage also includes a turbine section that is positioned adjacent a wall section of the center housing opposite the compressor housing and that is connected with and that forms a portion of the turbine housing. In an example embodiment, the turbine and/or compressor housings include one or more variable geometry members disposed therein.

Configured in this manner, the liquid-cooled center housing comprising the compressor section operates to maintain the compressor housing wall structure at a temperature below about 180° C. to minimize or eliminate the unwanted occurrence of oil deposits thereon, which ensures the unimpaired operation of variable geometry members within the compressor, thereby improving compressor efficiency and reducing needed variable geometry member actuation loads.

### BRIEF DESCRIPTION OF THE DRAWINGS

The details and features of the present invention will be more clearly understood with respect to the detailed description and drawings in which:

FIG. 1 is cross-sectional side elevation illustrating a prior art turbocharger assembly;

FIG. 2 is a cross-sectional view of an air-cooled center housing taken from the turbocharger assembly of FIG. 1;

FIGS. 3A to 3C are different cross-sectional views of a prior art turbocharger assembly comprising a center housing having a liquid cooling passage positioned adjacent the turbine housing;

FIG. 4 is a perspective view of a turbocharger assembly constructed in accordance with the principles of this invention comprising a center housing having an internal liquid cooling passage that is positioned adjacent a wall structure connected with the compressor housing.

FIGS. 5A to 5C are different cross-sectional views of a center housing constructed in accordance with the principles of this invention comprising an internal liquid-cooling passage that is positioned adjacent a center housing wall structure to be connected with a compressor housing; and

FIGS. 6A and 6B are perspective views of the internal liquid-cooling passage taken from the center housing of FIGS. 5A to 5C.

### DETAILED DESCRIPTION OF THE INVENTION

Turbocharger assemblies constructed according to principles of this invention comprise a center housing that is interposed between a turbine housing and a compressor housing. In an example embodiment, the turbocharger assembly comprises one or more variable geometry members disposed within the compressor housing for controlling the circulation of air therein. The turbocharger assembly center housing is specially engineered having an internal liquid cooling passage disposed therein and includes a compressor section that is positioned adjacent a wall structure connecting with the compressor housing. The internal liquid cooling passage can also extend along a wall structure of the center housing connecting with the turbine housing. Constructed in this manner, the center housing operates to maintain a desired wall structure temperature within the compressor housing during turbocharger operation to minimize or eliminate the formation or presence of oil deposits on the wall structure that can impair desired movement of the variable geometry member and reduce compressor efficiency.

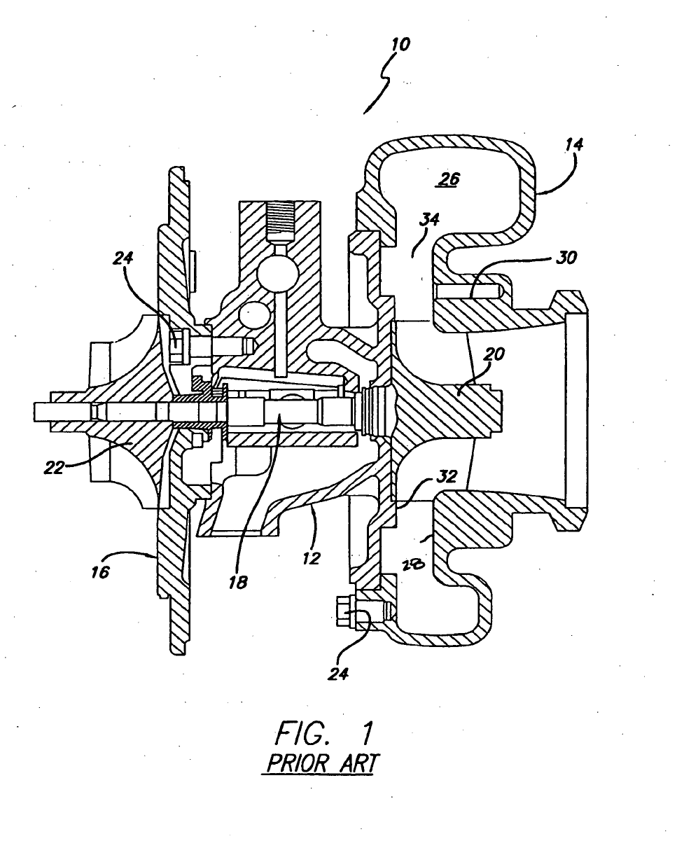

FIG. 1 illustrates a prior art turbocharger assembly 10, generally comprising a center housing 12 having a turbine housing 14 attached at one end, and a compressor backing plate 16 attached at an opposite end. A compressor housing is conventionally attached to the compressor backing plate. A shaft 18 is rotatably disposed within a bearing assembly contained within the center housing 12. A turbine or turbine wheel 20 is attached to one shaft end and is carried within the turbine housing 14, and a compressor impeller 22 is attached to an opposite shaft end and is carried within the compressor housing. The turbine housing and compressor housing are attached to the center housing by conventional manner, such as bolts 24 that extend therebetween. While the turbocharger assembly illustrated in FIG. 1 is constructed to accommodate variable geometry members in the turbine housing and/or compressor housing, such as a unison ring and a plurality of vanes, such members are not illustrated.

The turbine housing 14 includes a volute 26 that is in gas flow communication with an exhaust inlet for receiving exhaust gas and directing it to the turbine wheel. The turbine housing includes a nozzle wall 28 interposed between the volute and the turbine wheel. The nozzle wall 28 is configured to accommodate placement of the plurality of vanes. The center housing 12 includes a wall structure 32 opposite the nozzle wall that together operate to define a flow passage 34 from the volute to the turbine wheel.

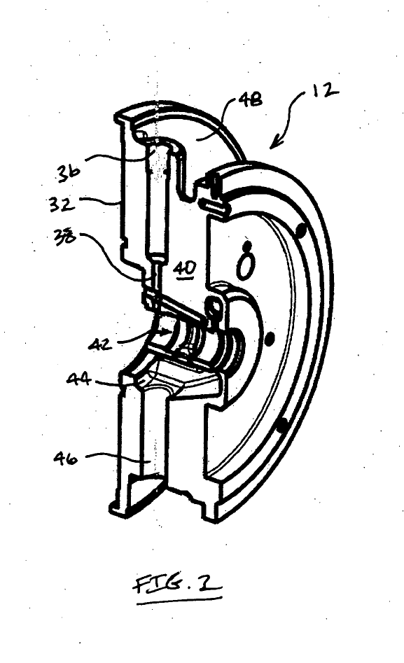

FIG. 2 illustrates the center housing 12 as comprising an oil inlet port 36 that is in communication with an oil inlet passage 38 extending radially into a body 40 of the housing for directing lubricating oil to the bearing assembly 42. The body 40 includes an oil outlet passage 44 that is configured to receive oil from the bearing assembly and direct it to an oil outlet port 46 for removal from the center housing. The prior art center housing 12 as illustrated in FIGS. 1 and 2, is an air-cooled assembly, in that heat generated in the turbine housing, and transferred to the center housing via the wall structure 32, is cooled by convention heat transfer from air surrounding an opposed outside surface 48 of the center housing wall structure 32.

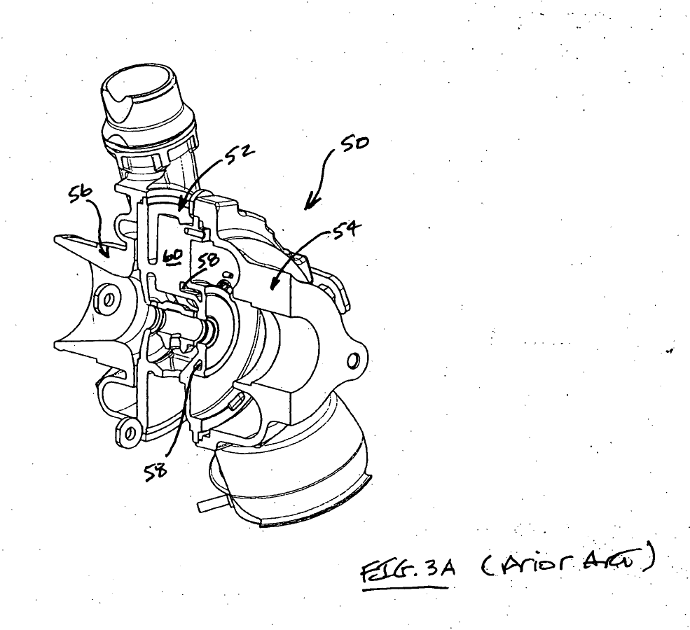

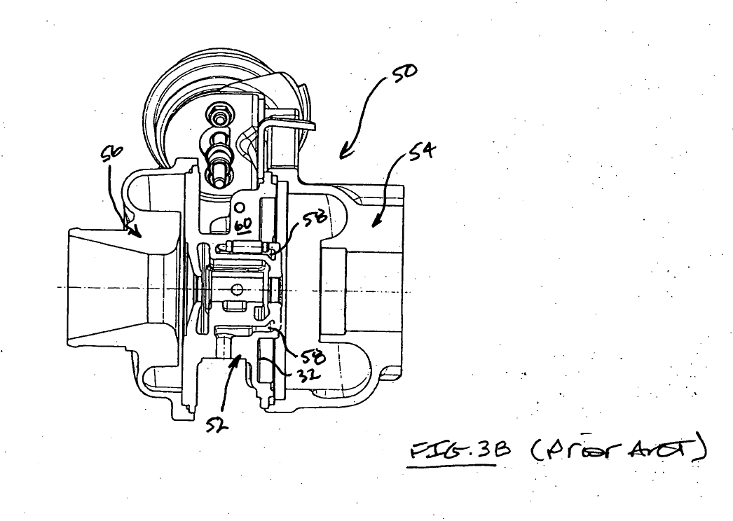

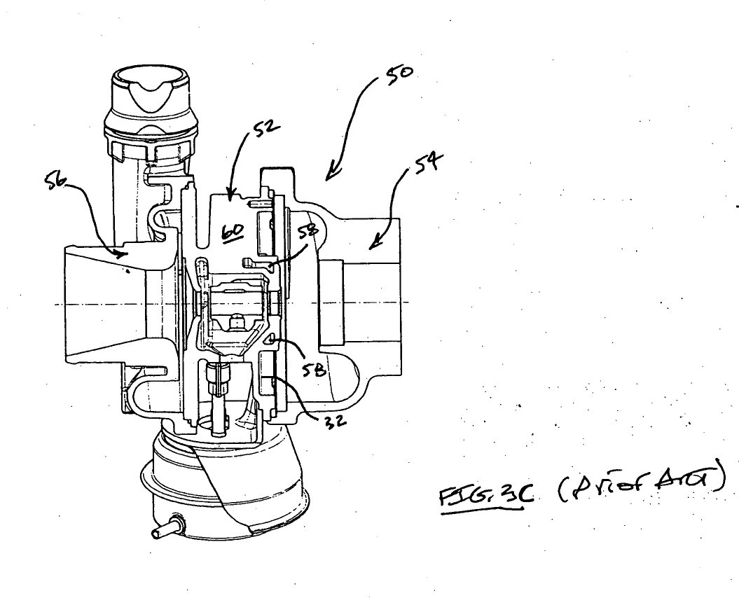

FIGS. 3A to 3C illustrate a prior art turbocharger assembly 50 comprising a center housing 52 interposed between a turbine housing 54 and a compressor housing 56. The turbine housing 54 is configured to accommodate a turbine wheel therein and the compressor housing is configured to accommodate a compressor impeller as noted above for the earlier prior art turbocharger assembly. Variable geometry members can be disposed within the turbine housing and/or compressor housing as noted above for the prior art turbocharger assembly of FIG. 1. However, unlike the earlier prior art turbocharger assembly, the center housing 52 for this turbocharger assembly includes, along with the oil inlet and outlet port use to route lubricating oil to and from the bearing assembly, an internal liquid cooling passage 58 that is disposed within the center housing body 60. The center housing includes a liquid inlet and a liquid outlet (not shown) for directing a desired cooling liquid into and out of the center housing.

The liquid cooling passage 58 in this prior art center housing 50 is one that is intentionally located within the center housing body 60 at a position adjacent and extending along an inside portion of the wall structure 32 to receive heat generated from the turbine housing. As illustrated in FIGS. 3A to 3C, the liquid cooling passage 58 extends within the body 60 at least partially around the centrally-positioned bearing assembly adjacent the wall structure 32 that forms part of the turbine housing 54. The liquid cooling passage 58 in such prior art liquid-cooled center housing is not positioned adjacent a wall structure connecting with the compressor housing.

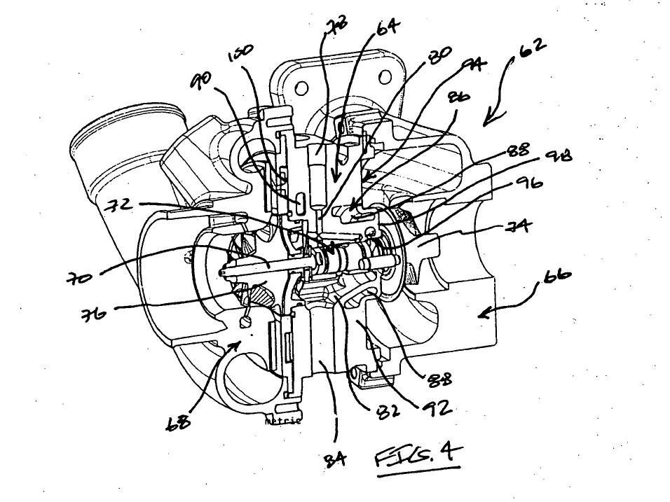

FIG. 4 illustrates a turbocharger assembly 62 constructed in accordance with the principles of this invention comprising a center housing 64 interposed between a turbine housing 66 and a compressor housing 68. The turbocharger assembly 62 includes a shaft 70 that is rotatably carried within a bearing assembly 72 disposed in the center housing 64, and that includes a turbine wheel 74 attached at one shaft end and a compressor impeller 76 attached an opposite shaft end. The turbine wheel and compressor impeller are rotatably disposed in the respective turbine and compressor housings. Variable geometry members can be positioned in the turbine housing and/or the compressor housing as noted for the above-identified turbocharger assemblies.

The center housing 64 includes an oil inlet port 78 that is in communication with an oil inlet passage 80, for facilitating the transport of a lubricating oil to the bearing assembly 72, and includes an oil outlet passage 82 and oil out port 84 for facilitate passage of oil from the bearing assembly and the center housing. Additionally, the center housing 64 is specially configured to accommodate passage of a liquid cooling medium therethrough for the purposes of controlling the temperature of the turbocharger assembly. Specifically, the center housing 64 is constructed having an internal cooling passage 86 that is configured comprising a turbine housing section 88 and, unlike the turbocharger assembly of FIGS. 3A to 3C, a compressor housing section 90.

The internal cooling passage turbine housing section 88 is positioned within the center housing body 92 so that it is adjacent the wall structure 94 of the center housing that forms a portion of the turbine housing. In an example embodiment, the cooling passage turbine housing section 88 is provided in the form of an annular passage that extends at least a partially around a shaft opening 96 through the center housing, and that extends axially into a neck portion 98 of the wall section that is adjacent the turbine wheel 74. Configured in this manner, the cooling passage turbine housing section operates to control amount of heat generated in the turbine housing and transferred to the center housing.

As shown in FIG. 4, the cooling passage compressor section 90 is positioned at an opposite axial end of the center housing adjacent a wall structure 100 forming a portion of the compressor housing 68. In an example embodiment, the cooling passage compressor section 90 is provided in the form of an annular passage that extends at least partially around the shaft opening 74 through the center housing, and that is positioned along a portion of the wall structure 100 that is adjacent a variable geometry member disposed within the center housing. Configured in this manner, the cooling passage compressor section operates to maintain a temperature along such wall section of less than about 180° C. to reduce or eliminate the formation of oil deposits therealong that can interfere with the desired movement of the variable geometry member.

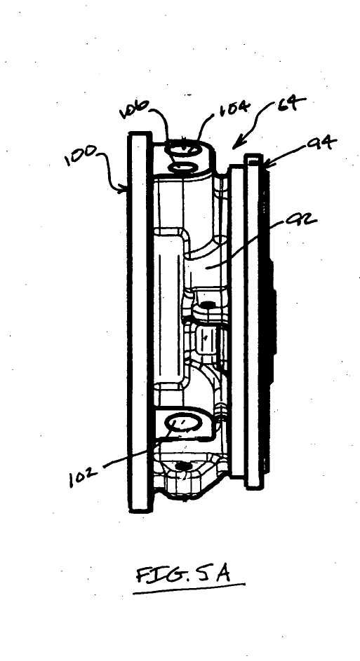

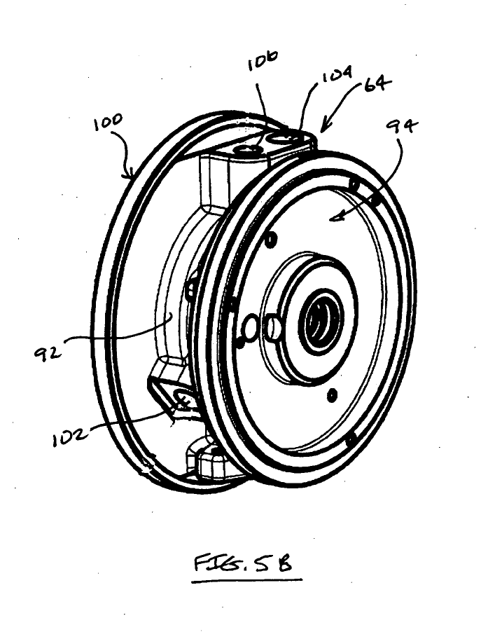

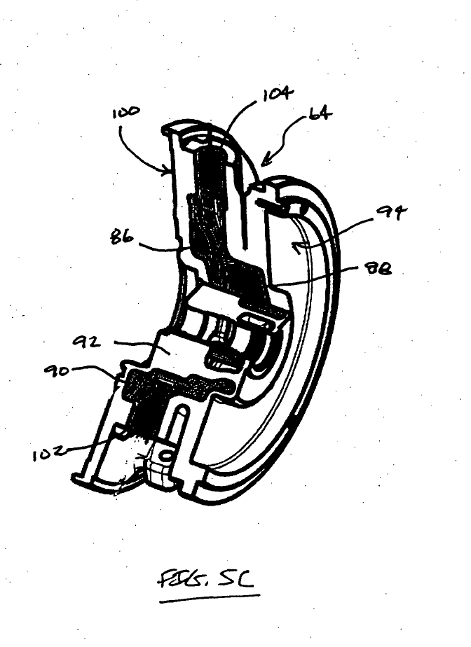

FIGS. 5A to 5C illustrate the center housing 64 as comprising a cooling liquid inlet 102 at one radial position along the body 92 and interposed between the turbine housing wall structure 94 and compressor housing wall structure 100. The cooling liquid inlet 102 is in fluid flow communication with the internal liquid cooling passage and the turbine and compressor sections of the passage. The center housing includes a cooling liquid outlet 104 that is positioned at a different radial position along the body 92 and that is in fluid flow communication with the internal cooling liquid cooling passage. In an example embodiment, the cooling liquid outlet 104 may be positioned adjacent the lubricating oil inlet port 104. In an example embodiment it is also desired that the liquid inlet port be positioned adjacent a bottom portion of the center housing to allow for thermosyphon liquid cooling.

The placement position of the cooling liquid inlet and outlet radially along the center housing body 92 is understood to vary depending on the particular use application. In an example embodiment, the placement position is dependent on a number of factors such as the packaging of the turbocharger assembly and the need to provide connection points that are located in places that do not interfere with other elements that will be attached to the turbocharger assembly, such as oil lines, vacuum lines, actuator assemblies and the like. Additionally, the placement position of the cooling liquid inlet and outlet ports will also be determined by heat transfer and liquid flow considerations of the cooling liquid within the center housing, e.g., to obtain the desired cooling liquid flow path within the internal passage.

In an example embodiment, the cooling liquid outlet is preferably mounted above the cooling liquid inlet for the purpose of bleeding or removing by gravity any air from within the internal cooling passage. Placing the cooling liquid inlet at a position along the center housing body that is lower than the cooling liquid outlet also facilitates thermosyphon liquid cooking when the internal combustion engine connected with the turbocharger assembly is off. In an example embodiment, the liquid cooling inlet and outlet ports are positioned at least about 45 degrees apart from one another.

FIG. 5C illustrates how the liquid inlet and outlet ports 102 and 104 are in fluid flow communication with the internal cooling liquid passage 86 disposed within the body 92. As noted above, the internal cooling liquid passage 86 is specially construction to include the turbine section 88 and the compressor section 90. Cooling liquid entering the center housing passes through the inlet port 102 and into the liquid passage 86 where it is distributed to both the turbine and compressor sections 88 and 90 for effecting the desired heat transfer from each of the respective turbine and compressor wall sections 94 and 100. Cooling liquids useful with such turbocharger assemblies include water and other cooling liquids conventionally used for heat transfer applications. In an example embodiment, the cooling liquid is water.

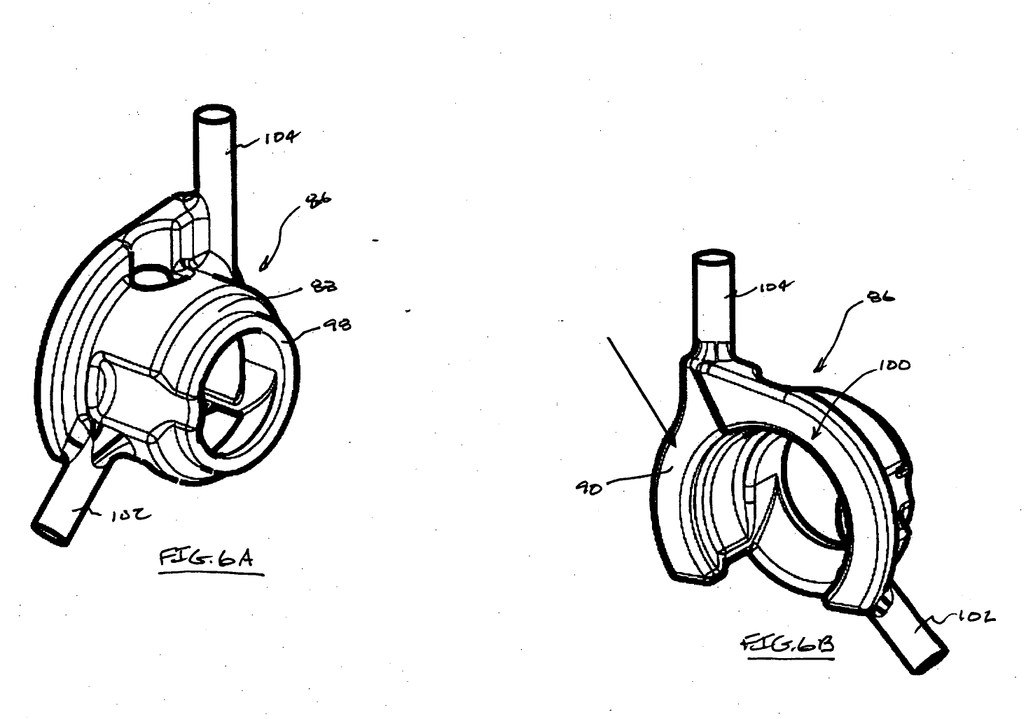

FIG. 5C also illustrates the relative positions of the compressor section 86 along wall structure 100, and the turbine section 88 along wall structure 94. In an example embodiment, the compressor section 100 has an outermost or outside diameter positioned along the wall structure 100 that is greater than a turbine section outermost or outside diameter positioned along the wall structure 94. Additionally, in such example embodiment, the compressor section has an innermost or inside diameter positioned along the wall structure 100 that is greater than a turbine section innermost or inside diameter positioned along the wall structure 94. The relative inside and outside diameters of the liquid cooling passage compressor and turbine sections are also illustrated in FIGS. 6A and 6B.

FIGS. 6A and 6B illustrate the internal liquid passage 86 with the liquid inlet port 102 and liquid outlet port 104 as removed from the remaining portion of the center housing body for the purpose of more clearly seeing the configuration of the same and the configuration turbine and compressor sections. As best shown in FIG. 6A, the internal passage turbine section 88 extends completely around the a central opening through the center housing, i.e., is made up of a 360 degree core portion of the passage, to provide a controlled amount of heat transfer from the turbine housing to the center housing.

FIG. 6A also illustrates the specific configuration of the turbine section 88 as extending axially along a portion of the passage forming the wall structure neck that extends within the turbine housing. Although FIG. 6A illustrates a turbine section of the internal liquid cooling passage extending a complete 360 degrees around the center housing central opening, it is to be understood that turbocharger assemblies of this invention may be configured having center housings with turbine sections of liquid cooling passages that may not comprise a 360 degree core and yet provide a desired degree of heat transfer from the turbine housing, and that such embodiments are within the scope of this invention.

As best shown in FIG, 6B, the internal passage compressor section 90 is shown to have a core that extends at least partially around a center housing central opening. The exact configuration of the internally passage compressor section 90 can and will vary depending on the desired heat transfer and/or cooling liquid flow characteristics within the center housing. I an example embodiment, the compressor section 90 is configured so that it does not extend a full 360 degrees around the central opening, thus does not extend along the full surface of the compressor wall structure, for the purpose of providing a desired cooling liquid flow path within the center housing that produces a maximized heat transfer surface exchange and a minimized pressure drop within the internal passage. For example, in the embodiment illustrated in FIGS. 6A and 6B, having a partial compressor section forces the cooling liquid to flow into the turbine section of the internal passage to meet the above noted design criteria.

In an example embodiment, the compressor section 90 comprises a core that extends partially around the central opening at least about 180 degrees, and more preferably approximately 270 degrees. While a particular example embodiment has been illustrated having a particularly configured compressor section core, it is to be understood that turbocharger assemblies having liquid cooled center housings with liquid passage compressor sections configured differently that that illustrated in FIGS. 6A and 6B are intended to be within the scope of this invention. For example, center housings of this invention can be configured having one or more baffles or the like disposed therein to provide a desired cooling liquid flow path therein in a manner permits the construction of a compressor section that extends completely around the central housing.

A factor driving the configuration of the compressor section core is the amount of heat transfer necessary to keep the wall structure of the compressor below about 180° C. during turbocharger operation. As noted above, it has been discovered that at above this temperature oil can deposit on the compressor wall structure and interfere with the proper movement of the variable geometry member that is positioned thereagainst. Accordingly, it is desired that the internal passage compressor section be configured in a manner that provides an amount of heat transfer reducing or eliminating the presence of such oil deposits.

Liquid-cooled center housings of this invention can be formed from conventional methods such as by machining, molding or casting, and can be formed from conventional materials used to make turbocharger assembly center housings, e.g., metallic materials. In an example embodiment, the center housing is made by mold process out of a metallic material.

A feature of turbocharger assemblies constructed in accordance with the principles of this invention, and as illustrated in FIGS. 4 to 6B, is the use of a liquid-cooled center housing having an internal liquid cooling passage comprising a compressor section that is configured to keep a wall structure of the compressor below a temperature of about 180° C. during turbocharger operation, thereby minimizing or eliminating the formation of oil deposits along the wall structure that could impair proper movement of a variable geometry member disposed within the compressor housing, e.g., positioned adjacent the wall structure. The impairment of proper variable geometry member movement within the compressor housing is not desired because it can both reduce compressor housing efficiency and require an increased actuation load to move the member.

Although specific embodiments of turbocharger assemblies comprising liquid-cooled center housings have been described above and illustrated, it is to be understood that modifications and variations of this configuration may be apparent to those skilled in the art, and that such modifications and variations are intended to be within the scope of this invention.

What is claimed is:

1. A turbocharger assembly comprising:
a turbine housing having a turbine wheel rotatably disposed therein;
a compressor housing comprising a compressor impeller rotatably disposed therein;
a center housing that is interposed between the turbine housing and compressor housing, the center housing including a shaft disposed axially therein and that is attached at one end to the turbine wheel and that is attached at an opposite end to a compressor housing, the center housing including a first wall structure at one axial end that is connected with the compressor housing, and a second wall structure that an opposite axial end that is connected with the turbine housing, the center housing comprising an internal liquid cooling passage for circulating a cooling liquid therein, wherein the internal liquid cooling passage includes a compressor section that is in fluid flow communication therewith and that is positioned adjacent the first wall structure to cool the first wall structure during turbocharger operation.

2. The turbocharger assembly as recited in claim 1 wherein the compressor section extends within the center housing less than 360 degrees around a central opening through the center housing.

3. The turbocharger assembly as recited in claim 1 further comprising a number of variable geometry members disposed within the compressor housing.

4. The turbocharger assembly as recited in claim 1 wherein the compressor section is configured to maintain a temperature of the first wall structure below about 180° C.

5. The turbocharger assembly as recited in claim 1 wherein the internal liquid cooling passage includes a turbine section that is in fluid flow communication with the internal liquid cooling passage and that is positioned adjacent the second wall structure to cool the second wall structure during turbocharger operation.

6. The turbocharger assembly as recited in claim 5 wherein the liquid cooling passage compressor section has an outside diameter along the first wall structure that is greater than an outside diameter of the liquid cooling passage turbine section that extends along the second wall structure.

7. The turbocharger assembly as recited in claim 5 wherein the liquid cooling passage compressor section has an inside diameter along the first wall structure that is greater than an inside diameter of the liquid cooling passage turbine section that extends along the second wall structure.

8. The turbocharger assembly as recited in claim 5 further comprising a number of variable geometry members disposed within the turbine housing.

9. The turbocharger assembly as recited in claim 3 further comprising a number of variable geometry members disposed within the turbine housing.

10. A turbocharger assembly comprising:
a turbine housing having a turbine wheel rotatably disposed therein;
a plurality of movable vanes disposed within the turbine housing;
a compressor housing having a compressor impeller rotatably disposed therein;
one or more moveable member disposed within the compressor housing;
a center housing interposed between the turbine housing and compressor housing, the center housing including a shaft disposed axially through a center housing central opening and that is attached at one end to the turbine wheel and that is attached at an opposite end to a compressor housing, the center housing including a first wall structure at one axial end that is connected with the compressor housing, and a second wall structure that an opposite axial end that is connected with the turbine housing, the center housing comprising an internal liquid cooling passage for circulating a cooling liquid therein, wherein the internal liquid cooling passage includes a compressor section that is in fluid flow communication therewith and that is positioned adjacent the first wall structure to cool the first wall structure during turbocharger operation.

11. The turbocharger assembly as recited in claim 10 wherein the internal liquid cooling passage includes a turbine section that is in fluid flow communication therewith and that is positioned adjacent the second wall structure to cool the second wall structure during turbocharger operation.

12. The turbocharger assembly as recited in claim 11 wherein the internal liquid cooling passage compressor section extends less than 360 degrees the central opening, and wherein the internal liquid cooling passage turbine section extends 360 degrees around the central opening.

13. The turbocharger assembly as recited in claim 12 wherein the compressor section extends about 270 degrees around the central opening.

14. The turbocharger assembly as recited in claim 11 wherein the liquid cooling passage compressor section has an outside diameter along the first wall structure that is greater than an outside diameter of the liquid cooling passage turbine section that extends along the second wall structure.

15. The turbocharger assembly as recited in claim 11 wherein the liquid cooling passage compressor section has an inside diameter along the first wall structure that is greater than an inside diameter of the liquid cooling passage turbine section that extends along the second wall structure.

16. The turbocharger assembly as recited in claim 10 wherein the internal liquid cooling passage compressor section is configured to maintain a temperature of the first wall structure below about 180° C. during turbocharger operation.

17. The turbocharger assembly as recited in claim 10 wherein the one or more movable member in the compressor housing comprises a plurality of vanes that are positioned downstream from the compressor impeller.

18. The turbocharger assembly as recited in claim 10 wherein center housing includes a liquid inlet port and a liquid outlet port each in fluid flow communication with the internal liquid cooling passage, and wherein the liquid inlet port is positioned adjacent a bottom portion of the center housing when the turbocharger assembly is mounted in an operating position.

19. A method for making a liquid-cooled center housing for use with a turbocharger assembly comprising a compressor housing and a turbine housing attached thereto, the method comprising the step of forming an internal liquid cooling passage that includes a compressor section in fluid flow communication therewith, the compressor section comprising an annular chamber extending partially around a central opening through the center housing and being positioned adjacent a wall structure that is connected to the compressor housing.

20. The method as recited in claim 1 further comprising forming a turbine section that is in fluid flow communication with the compressor section, the turbine section comprising an annular chamber that extends completely around the central opening and that is positioned adjacent a wall structure connected to the turbine housing.
